(19) United States
(12) Patent Application Publication
(10) Pub. No.: US 2005/0211235 A1
(43) Pub. Date: Sep. 29, 2005

(54) Portable cutting appartus

(76) Inventor: Anthony J. Governo, Buena Park, CA (US)

Correspondence Address: MCANDREWS HELD & MALLOY, LTD, 500 WEST MADISON STREET, SUITE 3400, CHICAGO, IL, 60661, US

(21) Appl. No.: 10/813,456

(22) Filed: Mar. 29, 2004

(51) Int. Cl. B23D 45/04

(52) U.S. Cl. 125/13.03

(57) ABSTRACT

An apparatus for cutting mineral-containing articles includes a table, blade support structure and a rotatable blade. The blade support structure has a cutting arm extending from the table that is capable of being moved in an arcuate cutting motion between an initial position away from the table and a cutting position toward the table. Where an article's longitudinal axis has a dimension that is less than the diameter of the rotatable blade, the apparatus is capable of cutting the article into two pieces in a single arcuate motion. The apparatus is also capable of deflecting dust created during cutting through the use of a guard member and an exhaust fitting connected to a vacuum pump.

### FIELD OF THE INVENTION

The present invention relates to a rotary cutting apparatus. More particularly, the present invention relates to a masonry and ceramic tile saw that includes a rotary cutting element and a stationary table. Although the present apparatus is useful for cutting masonry, ceramic tile or similar mineral-containing articles, the apparatus could be employed for other cutting applications as well.

### BACKGROUND IF THE INVENTION

Masonry and ceramic tile saws are commonly employed in the construction industry for cutting and shaping articles such as masonry tiles and the like, made from materials such as granite, marble, slate, ceramics, paver and brick. Articles that are cut and shaped by masonry and ceramic tile saws come in different shapes, sizes and hardnesses. A conventional masonry saw includes a movable tray on a cutting table that is generally supported on a floor standing frame, a cutting head above the cutting table and a rotary diamond saw blade powered by an electric motor. Conventional masonry and ceramic tile saws typically employ a liquid coolant such as water, circulated by a pump from a reservoir, serving the dual purpose of cooling the saw blade and the article being cut and capturing cutting wastes created by the sawing process.

Typically, larger, less portable saw devices are designed to make precise cuts at close tolerances. Devices, such as those employed in the building industry, are designed to resist damaging effects of the elements and to facilitate portability. Such design often leads to a loss in precision. For instance, when a saw device for cutting masonry units is decreased in size to facilitate portability, two cuts are often necessary when making long or deep cuts of larger articles since the saw cannot accommodate a blade sufficiently large for one clean cut. The cutting process with current portable masonry saws can include first cutting through half of an article, rotating the article 180 degrees and then cutting it again. Rarely will the same precision be obtained with a two-cut process as with a one-cut process.

Saws typically operate in the dry and simply rely on the surrounding atmosphere to cool the cutting blade. Rotary saws that operate in the dry produce what is referred to in the field as a “rooster tail” as the blade cuts into the article being shaped. This rooster tail consists of cutting wastes that will generally shoot tangential to the rotatable blade, at the contact point the blade makes with the article being cut, in the direction of blade movement. On saw configurations where the rotatable blade comes into contact with the article at the side of an article, the rooster tail tends in an upward direction. Concerns about rooster tails are ameliorated with masonry and ceramic tile saws that employ liquid coolants since the liquid often captures the cutting wastes created by the sawing process. A liquid cooled saw, however, requires additional tasks of a saw operator compared to saws that operate in the dry including maintenance and operational issues related to the liquid, pump, tubes and liquid reservoir.

A need exists for a saw that is compact and resistant to the elements that reduces maintenance and operator tasks, while maintaining a high level of precision, particularly when cutting masonry, ceramic tile or similar mineral containing articles.

### SUMMARY OF THE INVENTION

The present apparatus cuts masonry, ceramic tile and other mineral-containing articles, each of which has a longitudinal axis and a transverse axis. The apparatus comprises a table, a blade support structure and a rotatable blade.

The table is defined by a planar surface for supporting and positioning the article to be cut. The blade support structure projects from the table, and has a cutting arm extending away from the support structure. The cutting arm is pivotable about the support structure and is capable of being moved in an arcuate cutting motion between an initial position away from the table and a cutting position toward the table. The rotatable blade is mounted on the cutting arm. The rotatable blade has a diameter greater than a length of a longitudinal dimension of the article and in a single arcuate motion is capable of cutting the article into two pieces.

In one embodiment, the blade support structure comprises two angled elements where the angled elements both have a first end and a second end connected to a first rod and a second rod.

In other embodiments, the cutting apparatus further comprises several other features such as a motor for rotatably driving the blade, a guard member extending over an upper portion of the blade that further acts as a dust deflector, a torsion spring for balancing the cutting arm, an exhaust fitting for a vacuum pump, and a leverage arm extending from the cutting arm.

The cutting arm and support structure of the cutting apparatus provide tolerance control to the blade as the blade pivots on the blade support structure. The blade, as it pivots on the blade support structure, cuts the article from the top down through the article's entire bottom. The blade support structure and cutting can be poised so as to maintain the perpendicularity of the blade to the table.

In another embodiment, the cutting apparatus further comprises a cavity in the table capable of receiving edge portions of the blade. The cutting apparatus can also comprise a backstop removably secured to the table to stabilize the article during cutting.

Another embodiment is an apparatus for exhausting fluid from a cutting device mounted on a horizontal table. The apparatus comprises a vacuum pump and an exhaust fitting in fluid communication therewith. The fitting is capable of exhausting fluid in a stream generally parallel to the table, and comprises a funnel-shaped structure. The funnel-shaped structure has a receiving end shaped either trapezoidally or triangularly.

Another embodiment is an apparatus for deflecting dust from a cutting element. The apparatus comprises a guard member capable of generally encasing an upper portion of a rotatable blade. The guard member is shaped to deflect cutting waste to an exhaust fitting, with the exhaust fitting having a funnel shape such that the fitting and the guard member overlap upon urging the rotatable blade into a cutting motion.

Another embodiment has a rotatable blade with a segmented cutting surface, in which at least one of the segments terminates at its inner extent with cooling hole(s).

### BRIEF DESCRIPTION OF THE DRAWINGS

FIG. 1 is a front isometric view of one embodiment of the present portable table-mounted cutting apparatus.

FIG. 2 is a rear isometric view of the cutting apparatus illustrated in FIG. 1.

FIG. 3 is a top plan view of the cutting apparatus shown in FIGS. 1 and 2, with the cutting arm in an initial raised position.

FIG. 4 is a side elevation view of the cutting apparatus shown in FIGS. 1 and 2, with the cutting arm in an initial raised position.

FIG. 5 is a front elevation view of the cutting apparatus shown in FIGS. 1 and 2, with the cutting arm in an initial raised position.

FIG. 6 is a side elevation view of the cutting apparatus shown in FIGS. 1 and 2, with the cutting arm in a lowered, cutting position.

FIG. 7 is a rear elevation view of the cutting apparatus shown in FIGS. 1 and 2, with the cutting arm in a lowered, cutting position.

FIG. 8 is reverse side elevation view of the cutting apparatus shown in FIGS. 1 and 2, with the cutting arm in a lowered, cutting position.

FIG. 9 is an exploded isometric view of the cutting apparatus shown in FIGS. 1 and 2.

### DETAILED DESCRIPTION OF PREFERRED EMBODIMENT(S)

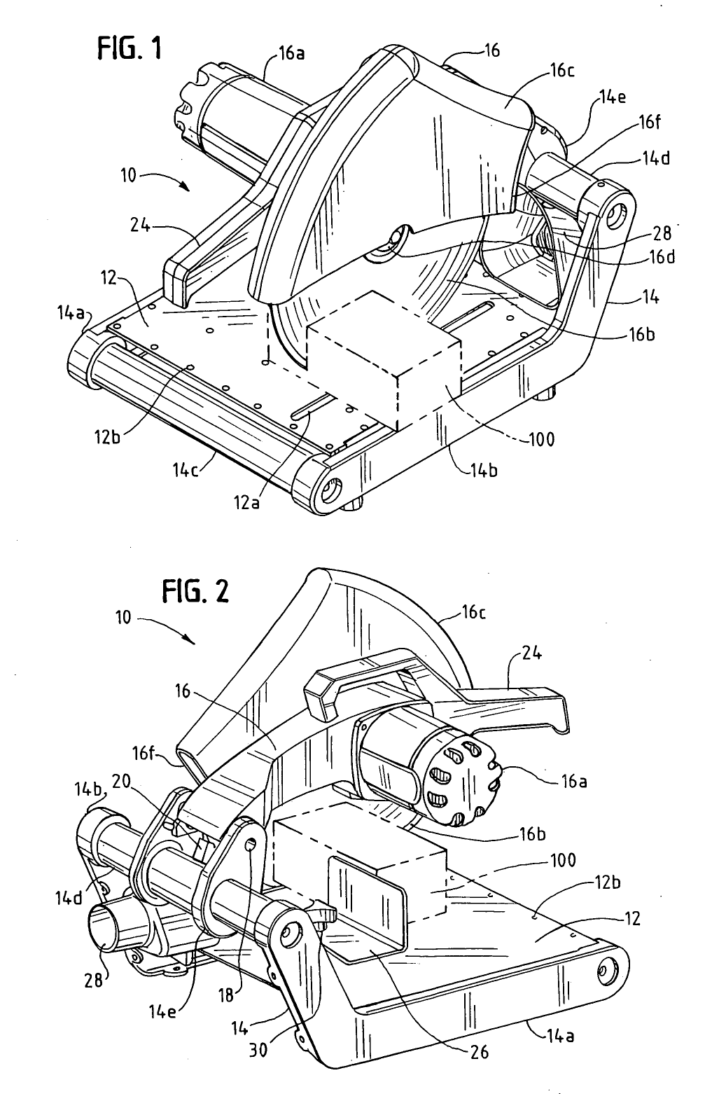

FIG. 1 illustrates a front isometric view of a cutting apparatus 10, according to an exemplary embodiment of the present apparatus. FIG. 2 illustrates a rear isometric view of the same cutting apparatus 10. Cutting apparatus 10 can include a table 12, which is generally a flat surface employed to support and position an article 100 to be cut or shaped by cutting apparatus 10. Articles 100 can include, but are not limited to, masonry tile, ceramics tile or similar mineral-containing objects. Other types of articles 100 where cutting apparatus 10 is useful include any type of article where there is a beneficial use of a circular saw for cutting and shaping of the object such as wood, plastic and metallic objects. Most articles to be cut are oblong and therefore have differential longitudinal and transverse axes. In articles having square or circular cross-sections the longitudinal and transverse axes are interchangeable.

A blade support structure 14 can support, or project from, table 12. Blade support structure 14 can consist of five primary elements. The first two elements can be angle portions 14a and 14b, which can mirror each other in forming a right and a left boundary of cutting apparatus 10. Angle portions 14a and 14b can be connected by the second two elements, rods 14c (not shown in FIG. 2) and 14d, which can be of any suitable shape and material to provide adequate support for cutting apparatus 10. Angle portions 14a and 14b can be shaped as angles with a varying bend comprising either a one-unit (as shown in FIGS. 1 and 2) or a multi-unit structure. Rods 14c and 14d can also be of any suitable shape including, but not limited to, square or cylindrical, hollow or solid. Angle portions 14a and 14b and rods 14c and 14d can be made of steel, aluminum or any other material of high-strength and rigidity that provides support for cutting apparatus 10. In FIG. 1, rods 14c and 14d (also shown in FIG. 2) are shown as tubes, which can allow for a more uniform attachment of the fifth element, a pivot clamp 14e, to blade support structure 14 and also allow for easier handling of cutting apparatus 10 by an operator. Pivot clamp 14e can be secured to rod 14d. Pivot clamp 14e is employed to support a cutting arm 16 that extends therefrom. Pivot clamp 14e also serves as a pivoting point 18 (shown on FIG. 2) for cutting arm 16. Other configurations for the blade support structure are envisioned such as any combination of the five primary elements as single or multiple units. An example would be combining rod 14d and pivot clamp 14e into a single unit that performs the functions of both elements. Another example would be combining angle portion 14a and rod 14c into a single unit. Blade support structure 14 can, along with or separately from table 12, serve as a base for cutting apparatus 10.

Pivot clamp 14e can be a spool-like structure with the two larger-diameter ends having symmetrical lobe-like structures instead of the circular structures normally expected on a spool-like structure. Other shapes for pivot clamp 14e are envisioned that can include a pin at pivot point 18 where cutting arm 18 can pivot. Pivot clamp 14e can be a solid or a hollow member and can be secured to rod 14d. Pivot clamp 14e can be slid onto rod 14d and/or clamped on such that a tight connection results between pivot clamp 14e and rod 14d.

Cutting arm 16 can extend from pivot clamp 14e out over table 12. A motor 16a, a rotatable blade 16b and a guard member 16c can be secured to cutting arm 16. Motor 16a is employed to drive rotatable blade 16b. Motor 16a can be positioned parallel to the table 12. Rotatable blade 16b is secured at a blade connection point 16d to a drive end 16e (shown on FIG. 5) of motor 16a. Guard member 16c fits over the upper portion of rotatable blade 16b. In addition to protecting the operator, guard member 16c can also serve as a dust deflector during sawing operations. Guard member 16c can be positioned such that the operator can view the article 100 during all cutting operations. Furthermore, the guard member can provide at least 181 degrees of coverage of the rotatable blade 16b to the operator during cutting operations.

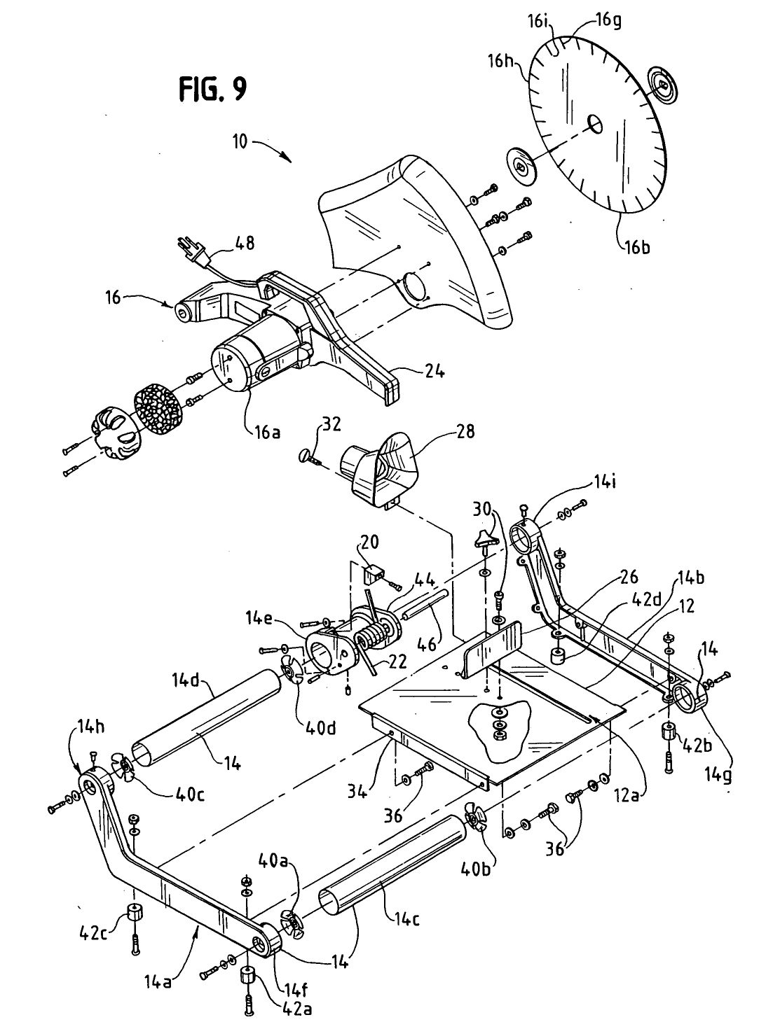

Cutting arm 16 can be a solid or hollow member and can be secured to pivot clamp 14e at pivot point 18 on the symmetrical lobe-like end of pivot clamp 14e. Cutting arm 16 can be of an arcuate or elliptical-arc shape. Cutting arm 16 allows motor 16a and rotatable blade 16b to pivot along a fixed radius from pivot point 18 in an arcuate motion. A stop block 20 (shown in FIG. 2) can be secured to pivot clamp 14e and be sized and positioned such that the stop block 20 limits the upward arc of cutting arm 16. A torsion spring 22 (shown in FIG. 9) can be positioned at pivot point 18 or elsewhere on pivot clamp 14e or rod 14d. The torsion spring 22 can balance the cutting arm 16 and any objects attached thereto such as the motor 16a, rotatable blade 16b, guard member 16c, and/or other attached objects. The downward arc of cutting arm 16 can be limited by the torsion spring 22. Other mechanical alternatives can be employed to limit the downward arc of cutting arm 16. The downward arc can also be limited by, cutting arm 16, blade connection point 16d or guard member 16c, directly contacting table 12. Cutting arm 16 can further be defined by a leverage arm 24 which can allow the operator to gain additional leverage or limit the amount of leverage applied during the cutting or shaping of an article 100.

Table 12 can have a generally rectangular shape and can be of a large enough size to allow it to rest on blade support structure 14. Table 12 can be secured to the support structure 14 using a suitable fastener. During operation of cutting apparatus 10, table 12 remains stationary and provides a supporting and positioning element for masonry, ceramic tile and other articles that are being cut or shaped. Table 12 can have a long slender cavity 12a (shown in FIG. 1) that aligns with the downward motion of rotatable blade 16b to allow passage of the bottom portion of rotatable blade 16b through table 12. Cavity 12a allows for a deeper cut into the article being cut or shaped. Table 12 can further include other small openings 12b (typical) in any number of configurations as shown in FIG. 1 and FIG. 2 as one example. The geometric layout of the small openings are but one configuration that can be employed for the cutting apparatus. The openings 12b allow for the passage of debris from the cutting operation or any other debris that can accumulate on table 12. Table 12 can be made of steel, aluminum or any other materials of high strength and rigidity. A backstop 26 (shown in FIG. 2) can be secured to table 12 to assist the operator in stabilizing article 100 being cut or shaped with cutting apparatus 10.

A dust collection fitting 28 can be secured to table 12 such that fitting 28 is in line to receive cutting wastes produced during cutting operations with rotatable blade 16b. Dust collection fitting 28 can be secured to table 12 toward the back of cutting apparatus 10 immediately behind the long axis of rotatable blade 16b and guard member 16c. A vacuum device (not shown) attached to dust collection fitting 28 collects the cutting wastes generated during the cutting or shaping operations of cutting apparatus 10. Dust collection fitting 28 combined with the vacuum device (not shown) can be particularly useful when working with brick or other siliceous materials where the cutting wastes can be harmful to the operator.

Cutting waste hazards can be further reduced where the shape of guard member 16c causes the streaming of the cutting wastes toward dust collection fitting 28. Such streaming of cutting wastes with guard member 16c into dust collection fitting 28 can occur where back end 16f is shaped such that back end 16f at least partially overlaps in an arc with the top portion of dust collection fitting 28.

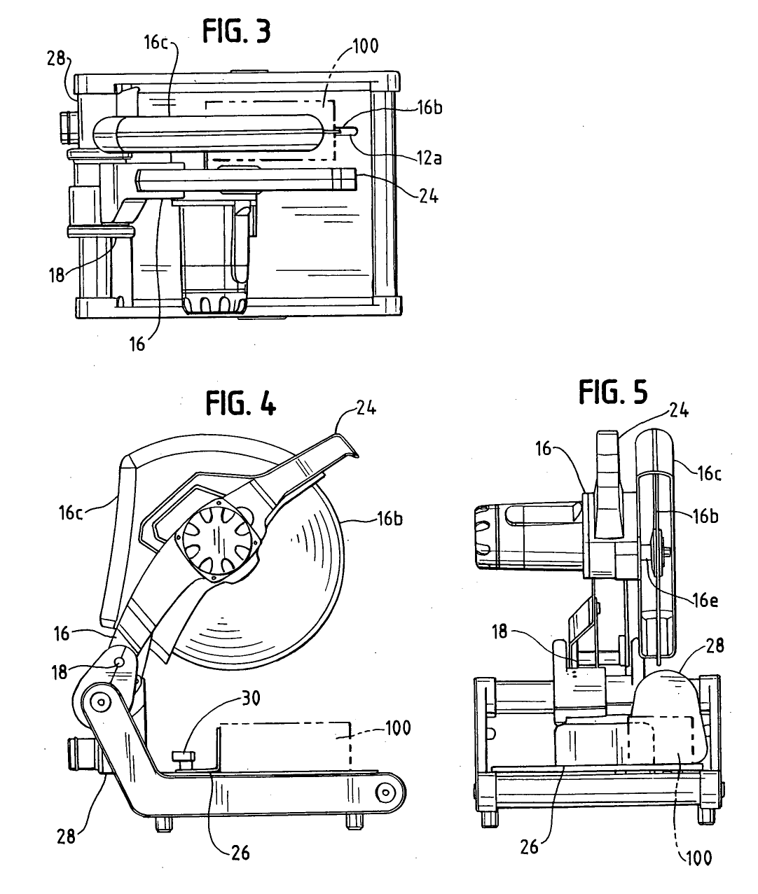

FIGS. 3, 4 and 5, respectively, illustrate a top plan view, a side elevation view and a front elevation view of cutting apparatus 10 shown in FIGS. 1 and 2. Reference is made to the same elements in FIGS. 3-5 as are shown in FIGS. 1 and 2. Cutting arm 16 is shown in an initial position for accepting an article 100 for cutting or shaping. Cutting arm 16 can be located in the initial resting position in FIGS. 3-5 prior to the operator applying pressure to the leverage arm 24 to commence cutting of an article 100. Cutting arm 16 can be moved downward in an arcuate motion relative to pivot point 18 such that rotatable blade 16b engages in contact with the top of article 100. As this contact occurs, guard member 16c and dust collection fitting 28 can be positioned such that the two overlap resulting in the majority of cutting wastes being streamed into dust collection fitting 28. As shown in FIGS. 3 and 5, rotatable blade 16b, guard member 16c and dust collection fitting 28 are located on the same plane such that the cutting wastes are directed toward dust collection fitting 28.

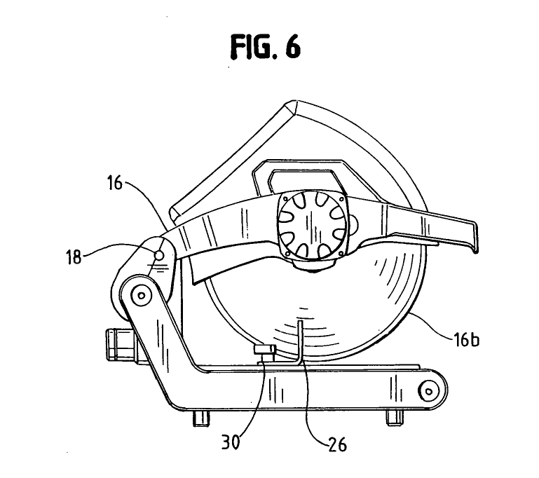

FIG. 6 illustrates a side view of the cutting apparatus shown in FIGS. 1 and 2 with cutting arm 16 in a cutting position. Reference is made to the same elements in FIG. 6 as are shown in FIGS. 1-5. As cutting arm 16 can be moved downward it enters to a cutting position where rotatable blade 16b engages the article (not shown) to be cut or shaped. Cutting arm 16 and rotatable blade 16b are generally coming in a downward direction toward the article to be cut or shaped. Cutting arm 16, as shown in a cutting position in FIG. 6, can be further moved in a downward direction through cavity 12a (shown in FIGS. 1 and 3) in table 12 such that a full cut can be made of the article in one single arcuate motion of cutting arm 16 relative to pivot point 18.

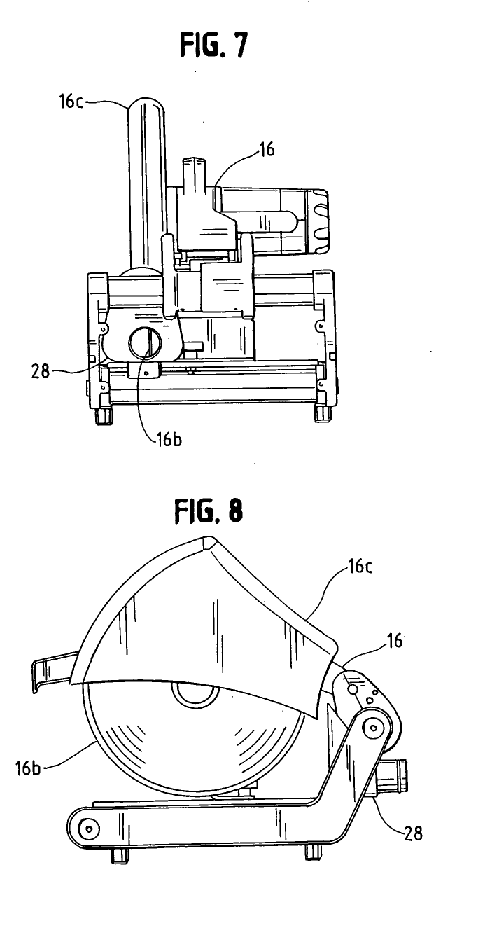

FIG. 7 illustrates a back view of the cutting apparatus shown in FIGS. 1 and 2. Reference is made to the same elements in FIG. 7 as are shown in FIGS. 1 and 6. FIG. 7 shows cutting arm 16 in a cutting position. In the cutting position, guard member 16c and dust collection fitting 28 can be positioned such that the two overlap resulting in the majority of cutting wastes being streamed into dust collection fitting 28. Rotatable blade 16b, guard member 16c and dust collection fitting 28 are located on the same plane such that the cutting wastes are directed toward dust collection fitting 28.

FIG. 8 illustrates reverse side view of the cutting apparatus shown in FIGS. 1 and 2. With cutting arm 16 in the cutting position, this view shows how guard member 16c and dust collection fitting 28 can overlap such that the cutting wastes are streamed into dust collection fitting 28. Fitting 28 provides a funnel point for a fluid vacuum device (not shown) for exhausting cutting wastes created by the cutting or shaping of articles. The open, triangular to trapezoidal, gently curving structure of the fitting allows for the streaming of the cutting wastes from rotatable blade 16b contact point with an article (not shown) during the sawing process.

FIG. 9 illustrates an exploded isometric view of a cutting apparatus 10, according to an exemplary embodiment of the present apparatus. As with the cutting apparatus shown in FIGS. 1 and 2, an exemplary embodiment of the present apparatus comprises a table 12, a blade support structure 14, a cutting arm 16, a motor 16a, and a rotatable blade 16b.

Table 12, in the FIG. 9 example, is rectangular in shape with a narrow slot 12a running the majority of the length of the long axis of table 12. A backstop 26 can be removably secured using screw-type fasteners 30 (also shown in FIGS. 2, 4 and 6) to table 12. Backstop 26 is employed for stabilizing articles that are being cut or shaped. One backstop position can be toward the center of table 12 for cutting or shaping articles along an axis much shorter than rotatable blade 16b diameter. A second backstop position can be toward the back of table 12 for cutting or shaping articles along an axis of a dimension nearer that of the diameter of rotatable blade 16b. Other positions for the backstop can be employed but are not shown in FIG. 9.

Dust collection fitting 28 can be removably secured to table 12 immediately behind a narrow cavity 12a along the axis where cutting or shaping occur. Dust collection fitting 28 can be secured using any mechanical methods such as a screw device 32.

Table 12 can be secured to a blade support structure 14 using a bracket 34 secured to table 12 and angle portions 14a and 14b. Brackets 34 can provide a friction fitting between angle portions 14a and 14b and table 12 when the brackets are secured using screws 36 received into angle portions 14a and 14b of blade support structure 14. Brackets 34 can alternatively be integral with table 12. Other mechanical methods of securing table 12 to blade support structure 14 can be employed.

Blade support structure 14 can include two angle portions 14a and 14b. Angle portion 14a and angle portion 14b both have a first end 14f, 14g and a second end 14h, 14i. First end 14f of angle portion 14a and first end 14g of angle portion 14b are connected by a first rod 14c. The second end 14h of angle portion 14a and the second end 14i of angle portion 14b are connected by a second rod 14d. Rods 14c and 14d can be made of steel, aluminum or other suitable high-strength, rigid material. Both rods can be connected at first ends 14f, 14g and second ends 14h, 14i with screws received by rod connectors 40a, 40b, 40c, 40d that are secured to the respective rod ends where the rod can be hollow. Blade support structure 14 can be supported at its based by four bumpers 42a, 42b, 42c, 42d bolted to angle portion 14a and angle portion 14b.

A pivot clamp 14e can be slid onto the second rod 14d to serve as a pivoting point and support for a cutting arm 16. Pivot clamp 14e comprises a stop block 20, a torsion spring 22, and a casting 44. The stop block 20 and torsion spring 22 serve to control the range of cutting arm 16 movement from the initial position shown in the side view of cutting apparatus 10 in FIG. 4 to the bottommost position where rotatable blade 16b extends through cavity 12a in table 12 below the cutting position shown in FIG. 8.

Cutting arm 16 connects with pivot clamp 14e using a pivot pin 46 that can slide through torsion spring 22. Motor 16a, guard member 16c and rotatable blade 16b can be connected to cutting arm 16. A motor 16a with a switch (not shown) and power cord 48 can be attached by any suitable mechanical method to cutting arm 16. A leverage handle 24 can be attached by any suitable mechanical method to the front of cutting arm 16.

Rotatable blade 16b can include segments 16g protruding inwardly that are approximately perpendicular to the outside edge 16h of the rotatable blade 16b. The segments 16g can be evenly distributed around the circumference so that the rotatable blade 16b maintains balance during cutting apparatus 10 operation. At least some of the segments 16g can terminate with cooling holes 16i. The cooling holes 16i assist with cooling the rotatable blade 16b during cutting operations. An exemplary embodiment for the rotatable blade includes approximately 24 segments 16g evenly spaced around a 14-inch (35.56-cm) diameter rotatable blade 16b, where the segments 16g protrude inwardly from the outside edge 16h approximately 0.25 inches (0.64 cm), each segment 16g terminating at its inner extent in a cooling hole 16i having a diameter of approximately 0.25 inches (0.64 cm).

Guard member 16c can be secured to cutting arm 16 using any of several fastening method including screws, other mechanical fasteners, or chemical fasteners. Rotatable blade 16b can be secured under guard member 16c to a motor 16a that can be secured to the opposite side of cutting arm 16. Rotatable blade 16b can be secured under guard member 16c to a power output end (not shown) of motor 16a through cutting arm 16 and guard member 16c. Guard member 16a can be of such a shape to cause a deflection and streaming of cutting wastes toward the back of cutting apparatus 10 during operation of the saw.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

1. An apparatus for cutting masonry, ceramic tile and other mineral-containing articles, each of the articles to be cut having a longitudinal axis and a transverse axis, the apparatus comprising:
(a) a table defining a planar surface for supporting and positioning said article;
(b) a blade support structure projecting from said table, said support structure having a cutting arm extending therefrom, said cutting arm pivotable about said support structure and capable of being moved in an arcuate cutting motion between an initial position away from said table and a cutting position toward said table; and
(c) a rotatable blade mounted on said cutting arm, said blade having a diameter greater than a length of a longitudinal dimension of said article, said blade capable of cutting said article into two pieces along said article's longitudinal axis in a single arcuate motion.

2. The apparatus of claim 1, further comprising a motor for rotatably driving said blade.

3. The apparatus of claim 2, wherein said motor is secured to said cutting arm such that said motor is parallel to said table.

4. The apparatus of claim 1, furthering comprising a guard member extending over an upper portion of said blade.

5. The apparatus of claim 4, wherein said guard member further acts as a dust deflector capable of directing cutting wastes to at least one of generally parallel to said table and generally tangential to said blade.

6. The apparatus of claim 4, wherein said guard member provides at least 181 degrees of coverage of said rotatable blade.

7. The apparatus of claim 1, furthering comprising an exhaust fitting for a vacuum pump, said fitting when equipped with said vacuum pump exhausts air in a stream generally toward said fitting generally parallel to said table.

8. The apparatus of claim 1, wherein said table is defined by a plurality of openings.

9. The apparatus of claim 1, wherein said cutting arm and said support structure provide tolerance control to said blade as said blade, secured to said cutting arm, pivots on said blade support structure.

10. The apparatus of claim 1, further comprising a torsion spring, said torsion spring placed where said cutting arm extends from said support structure, wherein said torsion spring balances said cutting arm with attached objects.

11. The apparatus of claim 1, wherein said cutting arm is arc shaped.

12. The apparatus of claim 1, wherein said cutting arm is elliptically arc shaped.

13. The apparatus of claim 1, wherein said blade, secured to said cutting arm, pivots on said blade support structure such that said blade cuts said article from a top of said article down through an entire bottom of said article.

14. The apparatus of claim 1, further comprising a cavity in said table for receiving edge portions of said blade.

15. The apparatus of claim 1, further comprising a backstop removably secured to said table to stabilize said article during contact with said blade.

16. The apparatus of claim 1, wherein said support structure comprises two angled elements, said angled elements both having a first end and a second end, where said first ends are connected by a first rod and said second ends are connected by a second rod.

17. The apparatus of claim 16, wherein at least one of said rods is cylindrical.

18. The apparatus of claim 16, wherein at least one of said rods is a tube.

19. The apparatus of claim 16, wherein said cutting arm pivots on support structure as defined by one of said tubes.

20. The apparatus of claim 1, wherein said blade support structure and said cutting arm poise said blade so as to maintain perpendicularity of said blade to said table.

21. The apparatus of claim 1, wherein said rotatable blade has a cutting surface comprising segments, at least one of said segments terminating with a cooling hole.

22. The apparatus of claim 1, wherein said blade support structure projects upwardly from said table.

23. The apparatus of claim 1, further comprising a leverage arm extending from said cutting arm.

24. An apparatus for exhausting fluid from a cutting device mounted on a horizontal table, said apparatus comprising a vacuum pump and an exhaust fitting in fluid communication therewith, said fitting capable of exhausting fluid in a stream generally parallel to said table, said apparatus comprising a funnel-shaped structure having one of (a) a trapezoidally shaped receiving end and (b) a triangularly shaped receiving end.

25. An apparatus for deflecting dust from a cutting element, said apparatus comprising a guard member capable of generally encasing an upper portion of a rotatable blade, said guard member shaped to deflect cutting waste to an exhaust fitting, said exhaust fitting having a funnel shape such that said fitting and said guard member overlap upon urging said rotatable blade into a cutting motion.
